(19) United States
(12) Patent Application Publication
(10) Pub. No.: US 2024/0331217 A1
(43) Pub. Date: Oct. 3, 2024

(54) OVERLAPPED-BLOCK CLUSTER COMPRESSION

(71) Applicant: TEXAS INSTRUMENTS INCORPORATED, Dallas, TX (US)

(72) Inventors: Jeffrey KEMPF, Dallas, TX (US); Jonathan LUCAS, Frisco, TX (US)

(21) Appl. No.: 18/497,994

(22) Filed: Oct. 30, 2023

Related U.S. Application Data
(60) Provisional application No. 63/493,321, filed on Mar. 31, 2023.

(51) Int. Cl. G06T 11/00; G06T 7/90; G06T 9/00; G06V 10/56; G06V 10/60; G06V 10/762

(52) U.S. Cl. CPC G06T 11/001; G06T 7/90; G06T 9/00; G06V 10/56; G06V 10/60; G06V 10/762; G06T 2207/10024

(57) ABSTRACT

An apparatus includes: a processor; and memory coupled to or included with the processor. The memory stores instructions that, when executed, cause the processor to: obtain an image; perform color palette cluster analysis on the image based on an initial set of colors, luminance sorting, and a target number of palettes; produce a compressed set of color palette keys responsive to the color palette cluster analysis; and output a compressed image based on the compressed set of color palette keys.

### CROSS REFERENCE TO RELATED APPLICATION

The present application claims priority to U.S. Provisional Application No. 63/493,321, titled “OVERLAPPED-BLOCK CLUSTER COMPRESSION WITH PERCEPTUALLY WEIGHTED COST FUNCTION”, Attorney Docket number T103165US01, filed on Mar. 31, 2023, which is hereby incorporated by reference in its entirety.

### BACKGROUND

In general, digital images require significant memory for storage and require significant time and bandwidth for transmission. Digital images are often compressed to reduce storage requirements and to reduce transmission time and bandwidth. There are lossless compression techniques and lossy techniques.

With block-based compression, phase variability is a challenge. For example, if an image is spatially shifted and compressed, the results will be different even though the input data is the same. This is due to each block of the image being compressed independently. Accordingly, a moving object will compress slightly differently based on spatial position.

### SUMMARY

In an example, an apparatus includes: a processor; and memory coupled to or included with the processor. The memory stores instructions that, when executed, cause the processor to: obtain an image; perform color palette cluster analysis on the image based on an initial set of colors, luminance sorting, and a target number of palettes; produce a compressed set of color palette keys responsive to the color palette cluster analysis; and output a compressed image based on the compressed set of color palette keys.

In another example, a system includes: an encoder; a decoder coupled to the encoder; and a spatial light modulation coupled to the decoder. The encoder is configured to: obtain an image; perform color palette cluster analysis on the image based on an initial set of colors, luminance sorting, and a target number of palettes; produce a compressed set of color palette keys responsive to the color palette cluster analysis; for a plurality of sub-blocks of the image, adjust the compressed set of color palette keys responsive to an overlap averaging analysis to produce an adjusted set of palette keys; and output a compressed image based on the adjusted set of palette keys. The decoder is configured to: receive the compressed image; and produce output data based on the compressed image. The spatial light modulator is configured to: receive the output data; and display a displayed image based on the output data.

In yet another example, a method includes: obtaining, by a processing device, an image; performing, by the processing device, color palette cluster analysis for a plurality of sub-blocks of the image, the plurality of sub-blocks including sub-blocks with co-located pixels; providing, by the processing device, a compressed set of color palette keys for each sub-block of the image responsive to the color palette cluster analysis; and averaging, by the processing device, respective color palette keys of the compressed set of color palette keys for each co-located pixel to obtain an adjusted set of color palette keys. The method also includes outputting, by the processing device, a compressed image based on the adjusted set of color palette keys.

### BRIEF DESCRIPTION OF THE DRAWINGS

FIG. 1A is a block diagram of a system in accordance with various examples.

FIG. 1B is a block diagram of another system in accordance with various examples.

FIG. 2 is a block diagram of a controller in accordance with various examples.

FIG. 3 is an image and related sub-block and graph of red-green-blue (RGB) value distribution in accordance with various examples.

FIG. 4 is a graph of RGB values and cluster centroid results in accordance with various examples.

FIG. 5 is a graph of RGB values and cluster initialization based on luminance sorting in accordance with various examples.

FIGS. 6A and 6B are diagrams showing sub-block traversal during cluster compression in accordance with various examples.

FIG. 7 is a graph of clusters and related centroids in accordance with various examples.

FIG. 8 is a graph of split clusters during cluster compression in accordance with various examples.

FIG. 9 is a graph of cluster compression results in accordance with various examples.

FIG. 10 is a diagram showing overlapping blocks and a resulting sub-block with co-located pixels in accordance with various examples.

FIG. 11 is a diagram showing spatially co-located pixels in accordance with various examples.

FIG. 12 is a spatially co-located palettes truth table and a related graph in accordance with various examples.

FIG. 13 is a block diagram of a processing system in accordance with various examples.

FIG. 14 is a method in accordance with various examples.

### DETAILED DESCRIPTION

The same reference numbers or other reference designators are used in the drawings to designate the same or similar features. Such features may be the same or similar either by function and/or structure.

In the described examples, integrated circuits (ICs) are used for image/video processing and/or image/video display operations. Example ICs may include microprocessors, controllers, specialty hardware, communication interfaces, memory, power management circuits, and input/output (I/O) terminals. One way to reduce the cost of related ICs while maintaining a target speed and image quality is to use a reduced memory size along with compression and decompression techniques. The reduced memory size reduces the IC size, which reduces cost. In some examples, the described compression and decompression options are leveraged to reduce a frame memory size. The described compression options may provide other benefits such as bandwidth reduction of data transfers, data transfer rate reduction, data transfer power consumption reduction, and/or a reduction in the number of input/output terminals used for data transfers (e.g., a size/cost reduction).

In the described examples, each image includes a multi-bit color code for each pixel of the image. In some examples, the compression techniques described herein, overlapped-block cluster compression, are applied to colors of an image and reduce the dimensionality of the multi-bit color codes. In such examples, the compression results include compressed multi-bit color codes for respective pixels of an image, where the number of bits in each compressed multi-bit color code is reduced compared to a respective initial multi-bit color code. As used herein, the “overlapped-block” aspect of overlapped-block cluster compression refers to compression techniques that are applied to overlapping sub-blocks of an image, where overlapping portions of the sub-blocks share spatially co-located pixels. With overlapping sub-blocks, the boundary artifacts of neighboring sub-blocks are reduced. In other words, the described overlapped-block cluster compression accounts for variance in the compression results for neighboring sub-blocks by averaging, or otherwise combining, the compression results of spatially co-located pixels.

As used herein, the “cluster compression” aspects of overlapped-block cluster compression refers to compression techniques that use cluster analysis (e.g., color palette cluster analysis) to reduce the dimensionality of image data, such as color. In some examples, cluster compression groups pixels of an image into clusters based on their location in red-green-blue (RGB) space. The initial clusters are known as parent clusters. Some or all of these parent clusters are then split into smaller clusters known as child clusters. The pixels in a given cluster are each represented by a single RGB value, which is located at the centroid of the given cluster. Also, cluster compression may incorporate a key encoding scheme that is tailored to the human visual system. In some examples, red, green, and blue pixel distance values are weighted according to photopic sensitivity.

Because most RGB data in a localized region of an image or video is naturally clustered, cluster compression produces little to no observable loss of information. With cluster compression staying entirely in the spatial domain, the related compute loads are much lower than algorithms that use transform encoding techniques. Accordingly, cluster compression has relatively low power consumption while providing compression results and related benefits (e.g., memory size reduction and/or bandwidth savings). The compression results include a compressed version of an original image.

The overlapped-block cluster compression techniques described herein compresses data in RGB space to produce a compressed image. However, other suitable types of data can be compressed using the techniques herein. In some examples, the compression process described herein compresses a collection of N objects to a number less than N by analyzing error metrics. In such examples, the objects are RGB pixels and the error metric is maximum absolute distance (described below). In other examples, the objects and error metrics may vary.

In one example, the overlapped-block cluster compression techniques described herein reduce the size of a bit plane frame memory and reduce 1/O bandwidth. Without limitation, I/O bandwidth may be reduced from 30 bits per pixel (bpp) to 11 bpp. In some examples, the compression is based on a fixed compression ratio or target (e.g., 11 bpp). The compression techniques also reduce the compute load compared to other compression techniques to minimize die area and power consumption. For examples, in some examples, the overlapped-block cluster compression techniques include luminance sorting to initialize a target number of centroids for cluster analysis so that the number of cluster splitting iterations as well as the overall amount of calculations is reduced. For each cluster splitting iteration, divisions may be performed to calculate metrics used to determine which cluster should be split. In some examples, overlapped-block cluster compression operations use a combination of division estimation and periodic use of a true divider during cluster splitting iterations to reduce the number of true dividers used (providing a size/cost benefit).

In some examples, a related decoder operates in bit plane space with relatively high clock rates. Reducing the size of the bit plane frame memory and the I/O bandwidth are two ways to reduce decoder complexity while maintaining relatively high image quality as determined by subjective analysis (e.g., observation of decompressed images on real systems) and objective metrics. Example objective metrics include mean squared error (MSE), adjacent peak signal-to-noise ratio (PSNR), a structured similarity indexing method (SSIM). In some examples, decompression of cluster compression encoded images may use a look-up table (LUT). The LUT may store pixel key assignments, where the key determines the appropriate palette or cluster centroid to which a pixel is assigned.

In some examples, the amount of memory used for an 8×8 block of an image may be based on a first set of bits that indicate the number of palettes, a second set of bits that indicate palette keys for the block, and third set of bits that indicate an all-black block. In some examples, the first set of bits is determined as: (16 palettes/color)×(10-bits/color)×(3 colors/palette)=480 bits. In some examples, the second set of bits is determined as: (4 bits/pixel)×(64 pixels/block)=256 bits. In some examples, the third set of bits is determined as: 1 bit/block. In such examples, the bits per pixel is determined as: (480+256+1)/64 pixels=11.515625 bpp. If x=% of block blocks, the write-side bandwidth (WSB) is given as: x*0.015625 bpp+(1−x)*11.515625 bpp. The read-side bandwidth (RSB) is dependent upon the number of bit loads in sequence. In some examples, the palette information for given a bit plane color is given as: (64 pixels/block)×(4-bit key/pixel)+(16 palettes/color)×(10-bits/color)×(1 color/bit load)+(1-bit all-black flag/block)=256+160+1=417 bits/block/64 pixels/block=6.515625 bpp. If there are 36 bit loads, then RSB=36*(x*0.015625 bpp+(1−x)*6.515625 bpp)=x*0.5625 bpp+(1−x)*234.562 and the total memory bandwidth=WSB+RSB=x*0.578125+(1−x)*241.078125.

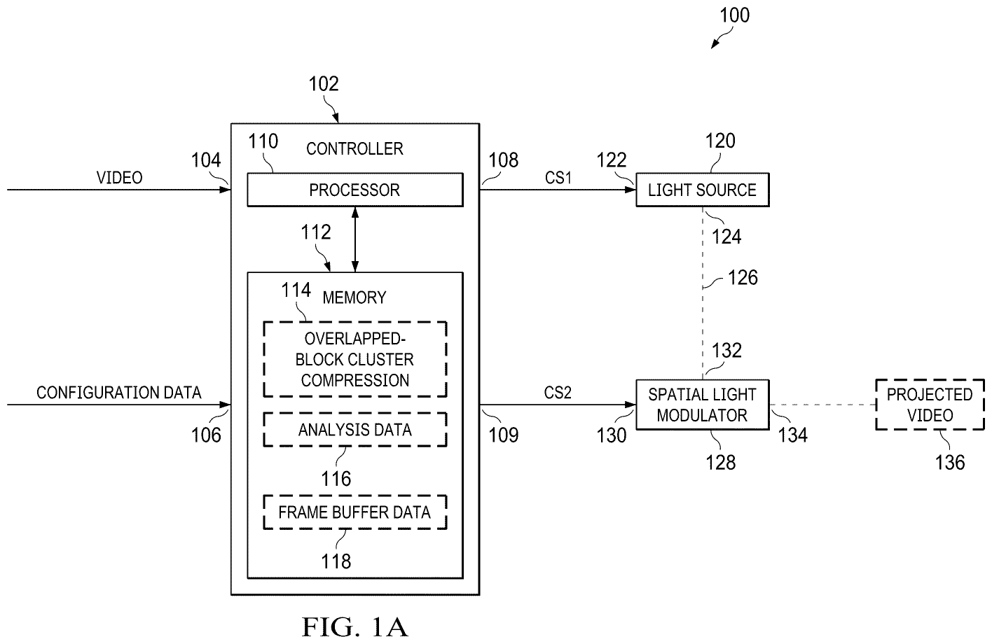

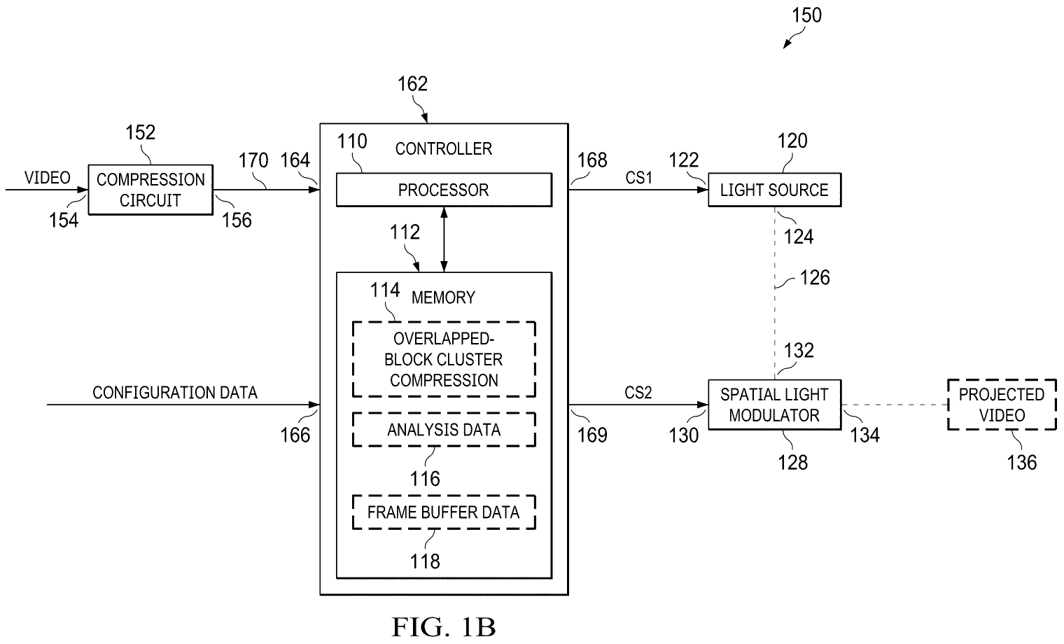

FIG. 1A is a block diagram of a system 100 in accordance with various examples. In some examples, system 100 is a projector, for example a traditional projector, an augmented reality (AR) display, a virtual reality (VR) display, a smart headlight, a heads-up display (HUD), automotive ground projection, a LIDAR unit, a lithography unit, 3D-printer, a spectroscopy display, a 3D display, or another type of projector. The example system 100 is not intended to be limiting and the compression techniques described herein may be used is any other system to compress images and reduce memory footprint. As shown, system 100 includes a controller 102, a light source 120, and a spatial light modulator 128. Controller 102 has a first terminal 104, a second terminal 106, a third terminal 108, and a fourth terminal 109. The light source 120 has an input 122 and an optical output 124. The spatial light modulator 128 has an input 130, an optical input 132, and an optical output 134.

In the example of FIG. 1A, controller 102 includes a processor 110 and a memory 112. The processor 110 can be a central processing unit (CPU), a graphics processing unit (GPU), or a specialized processor or controller programmed to perform compression operations. In different examples, the processor 110 may include a processing pipeline, buffering, and control logic for performing compression operations. Also, the processor 110 may include multiple processors, controllers, or engines to perform compression operations. In one example, the processor 110 uses buffering and logic with a pipelined data path architecture to perform the compression operations described herein. When processing a block of pixels, calculations on one pixel generally finish before calculations on another pixel begins. Therefore, a straightforward pipelined data path architecture can have difficulties performing overlapped-block cluster compression or other compression operations, as no two pieces of data from the same block are in the pipeline simultaneously. However, data from different blocks can be in the pipeline simultaneously. By adding buffering and logic around the pipeline, the processing of multiple blocks can be interleaved using the same pipeline logic.

Interleaving blocks in a single pipeline can present some limitations, as the single pipeline becomes a bandwidth bottleneck. Duplicating the pipeline increases bandwidth, but at the cost of logic area. In an example, the processing, buffering, and control logic are bundled into a cluster compression engine. A processing system can include multiple processing engines. The number of processing engines and an interleaving factor can be varied to ensure that an available compression bandwidth is in line with the compression bandwidth used by the compression tasks being performed. As used herein, “interleaving factor” refers to the number of processing queues and related stages of pipelined hardware for a processing engine. When queuing blocks of an image for compression operations, multiple blocks of the image are processed through different stages of the pipelined hardware of a processing engine in a manner that reduces the amount of waiting time for each processing stage and improves the overall processing speed relative to processing one block at a time. In one example, eight processing engines could be used, with each processing engine interleaving 32 blocks. In this example, the interleaving factor is 32. In other examples, the number of processing engines and the interleaving factor may vary. Without limitation, the number of processing engines may be two, four, six, eight, ten, or another integer number of processing engines. Without limitation, the interleaving factor may be two, four, eight, sixteen, or another integer number.

The memory 112 can include read-only-memory (ROM), random access memory (RAM), electrically erasable programmable read-only memory (EEPROM), flash memory, and/or other non-transitory computer readable memory types. In some examples, the memory 112 store overlapped-block cluster compression instructions 114, analysis data 116, and frame buffer data 118. The memory 112 may also store image data, pixel data, and any other data used by processor 110 to perform recurve compression operations or results (not pictured). In some examples, the memory 112 may store a key for each pixel of an image, where the key denotes the palette to which each pixel is assigned. In some examples, the memory 112 is configured to store a control bit for a sub-block of pixels, where the control bit indicates a type of encoding for the sub-block.

As shown, the first terminal 104 of the controller 102 receives video input. The second terminal 106 of controller 102 receives configuration data. The third terminal 108 of controller 102 is coupled to the input 122 of the light source 120. The fourth terminal 109 of controller 102 is coupled to the input 130 of the spatial light modulator 128. The optical output 124 of the light source 120 is coupled to optical input 132 of the spatial light modulator 128. The optical output 134 of the spatial light modulator 128 provides a projected video 136.

In some examples, controller 102 is configured to: receive video at its first terminal 104; receive configuration data at its second terminal 106; provide a first control signal (CS1) at its third terminal 108 responsive to the video data and the configuration data; and provide a second control signal (CS2) at its fourth terminal 109 responsive to the video data and the configuration data. In some examples, the configuration data includes a video resolution configuration, a high-frequency sampling order, and/or other configuration options. In some examples, CS1 is a light intensity control signal for the light source 120. The light source 120 is configured to provide light 126 at its optical output 124 responsive to CS1. In different examples, CS2 may include pulse-width modulation (PWM) control signals, bit plane data, an offset voltage, a bias voltage, a reset voltage, a power supply voltage, and/or other control signals or voltages for the spatial light modulator 128.

In some examples, the spatial light modulator 128 is configured to provide a projected video 136 responsive to the light 126 and CS2. The projected video may be based on compressed images and/or decompressed images. In some examples, the spatial light modulator 128 includes a Low Voltage Differential Signaling (LVDS) interface to receive control signals. Without limitation, the spatial light modulator 128 may include micromirrors and a two-dimensional array of memory cells. The positive or negative deflection angle of the micromirrors can be individually controlled by changing the address voltage of underlying memory addressing circuitry and micromirror reset signals (MBRST). In some examples, the spatial light modulator 128 receives bit planes through one or more LVDS input interfaces and, when input control commands dictate, activates the controls which update the mechanical state of the micromirrors.

In some examples, the processor 110 determines CS2 based on compression of images of the video. Such compression of images of the video is based on instructions and data stored in the memory 112. Example instructions and data of the memory 112 include the overlapped-block cluster compression instructions 114, the analysis data 116, and the frame buffer data 118.

In some examples, execution of the overlapped-block cluster compression instructions 114 results in the analysis data 116 (e.g., PCC analysis data, gradient analysis data, entropy analysis data). The analysis data 116 is stored and analyzed during each iteration of the processor 110 executing the overlapped-block cluster compression instructions 114. In some examples, the final results of the overlapped-block cluster compression instructions 114 may include compressed palette keys and/or other data used to encode the frame buffer data 118. In some examples CS2 includes or is based on the frame buffer data 118. In some examples, compression operations are performed by another integrated circuit (IC) (e.g., an upstream circuit such as the compression circuit 152 in FIG. 1B) and the compression results are sent to the controller 102. In such examples, the controller 102 may transfer and/or store the compression results. As part of display operations (performed upon receipt of compression results or later), the controller 102 may perform decompression operations. Compared to the original image (before compression is performed), a decompressed image may be fully decompressed or partially decompressed. In different examples, the frame buffer data 118 may include the compression results or decompression results. Likewise, CS2 may include the compression results or the decompression results. When another IC performs the compression operations, the compression results save bandwidth and power on the interface between the other IC (not shown) and the controller 102. In other examples, the controller 102 may perform compression, compression results transfers, and/or decompression internally. In such examples, the compression reduces the bandwidth of internal video transfers and/or the memory footprint of image/video storage for the controller 102.

FIG. 1B is a block diagram of another system 150 in accordance with various examples. As shown, the system 150 includes the components of the system 100. In addition, the system 150 includes a compression circuit 152 and a controller 162. The compression circuit 152 has a first terminal 154 and a second terminal 156. In different examples, the compression circuit 152 may be a processor, a compression controller, or another circuit. The controller 162 has a first terminal 164, a second terminal 166, a third terminal 168, and a fourth terminal 169.

In the example of FIG. 1B, the first terminal 154 of the compression circuit 152 receives video. The second terminal 156 of the compression circuit 152 is coupled to the first terminal 164 of the controller 162 via an interface 170. The second terminal 166 of the controller 162 receives configuration data (e.g., from a processor or other configuration data source). The third terminal 168 of controller 162 is coupled to the input 122 of the light source 120. The fourth terminal 169 of controller 162 is coupled to the input 130 of the spatial light modulator 128.

In some examples, the compression circuit 152 may perform image compression operations instead of, or in addition to, the controller 162. In such examples, the compression circuit 152 may include a processor and a memory similar to the processor 110 and the memory 112 described for the controller 102 of FIG. 1A. The controller 162 of FIG. 1B includes the processor 110 and the memory 112 described in FIG. 1A and may perform operations similar to the controller 102 of FIG. 1B. In some examples, when the compression circuit 152 performs image compression, the compression results are provided to the controller via the interface 170. The controller 162 may perform additional compression, compression results transfers, decompression, and/or other control operations to prepare CS2 for the spatial light modulator 128. The compression results of the compression circuit 152 and/or of the controller 162 enable a reduction in frame memory size of the controller 162. The described compression may provide other benefits such as bandwidth reduction of data transfers, data transfer rate reduction, data transfer power consumption reduction, and/or a reduction in the number of input/output terminals used for data transfers (e.g., a size/cost reduction). In some examples, the controller 102A of FIG. 1, the compression circuit 152 of FIG. 1B, or the controller 162 of FIG. 1B may compress images, including images of a video, where each image includes a multi-bit color code for each pixel of the image. In some examples, overlapped-block cluster compression applies cluster compression to colors of each image and reduces the dimensionality of the multi-bit color codes. In such examples, the compression results include compressed multi-bit color codes for respective pixels of each image, where the number of bits in each compressed multi-bit color code is reduced compared to a respective initial multi-bit color code. The overlapped-block aspect of overlapped-block cluster compression applies compression to overlapping sub-blocks of the image, which reduces boundary artifacts of neighboring sub-blocks. In some examples, overlapped-block cluster compression accounts for variance in the compression results for neighboring sub-blocks by averaging, or otherwise combining, the compression results of spatially co-located pixels.

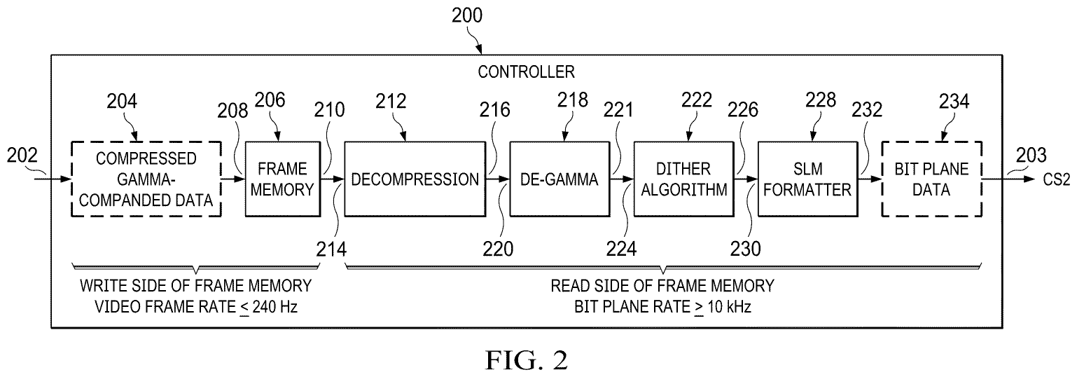

In some examples, overlapped-block cluster compression groups pixels of an image into clusters based on their location in RGB space. The initial clusters are known as parent clusters. Some or all of these parent clusters are then split into smaller clusters known as child clusters. The pixels in a given cluster are each represented by a single RGB value, which is located at the centroid of the given cluster. Also, cluster compression may incorporate a key encoding scheme that is tailored to the human visual system. In some examples, red, green, and blue pixel distance values are weighted according to photopic sensitivity. With overlapped-block cluster compression, the size of the memory 112, or the size of the frame buffer data 118 stored in the memory 112 of the controller 102 in FIG. 1A or the controller 162 in FIG. 2B is reduced. Also, the bandwidth of external or internal interfaces that transfer compressed data is improved.

In some examples, an apparatus (e.g., the controller 102 in FIG. 1A, the compression circuit 152 in FIG. 1B, the controller 162 in FIG. 1B, or a related system) includes: a processor (e.g., the processor 110); and memory (e.g., the memory 112) coupled to or included with the processor, the memory storing instructions (e.g., the overlapped-block cluster compression instructions 114). When executed, the instructions cause the processor to: obtain an image; perform color palette cluster analysis on the image based on an initial set of colors, luminance sorting (luminance sorted values), and a target number of palettes; produce a compressed set of color palette keys responsive to the color palette cluster analysis; and output a compressed image based on the compressed set of color palette keys.

In some examples, the instructions, when executed, further cause the processor to perform the luminance sorting (to obtain luminance sorted values) by: obtaining RGB value for each color of the initial set of colors; converting each RGB value to a luminance value, each RGB value having a first number of bits, each luminance value having a second number of bits, the second number of bits being less than the first number of bits; and sorting the luminance values to obtain a sorted index of luminance values. In some examples, the instructions, when executed, further cause the processor to perform the luminance sorting by: partitioning the sorted index of luminance values into a target number of bins; selecting center values for each of the bins; and initializing the color palette cluster analysis responsive to each of the center values. In some examples, the bins have the same number of sorted luminance values and the center values for respective bins have RGB values corresponding to colors of the initial set of colors.

In some examples, the instructions, when executed, cause the processor to perform the luminance sorting and color palette cluster analysis for each of a plurality of sub-blocks of the image, the color palette cluster analysis including: adding pixels to the color palette cluster analysis based on a spatial pattern that skips over adjacent pixels; and adjusting cluster centroids responsive to each pixel being added. In some examples, the instructions, when executed, cause the processor to perform the color palette cluster analysis for each sub-block by: performing a target number of clustering iterations; for each clustering iteration, obtaining a set of color palette keys; and, for each clustering iteration, dividing the set of color palette keys based on the target number of palettes.

In some examples, the instructions, when executed, cause the processor to: adjust the compressed set of color palette keys, for each of a plurality of sub-blocks of the image, responsive to an overlap averaging analysis; and output a compressed image based on the adjusted set of color palette keys. In some examples, the overlap averaging analysis includes: obtaining the compressed set of color palette keys for each of the plurality of sub-blocks of the image; identifying co-located pixels of the plurality of sub-blocks; and, for each co-located pixel, averaging respective color palette keys of the compressed set of color palette keys to obtain an adjusted set of color palette keys. In some examples, the instructions, when executed, further cause the processor to identify the co-located pixels of the sub-blocks based on truth table analysis.

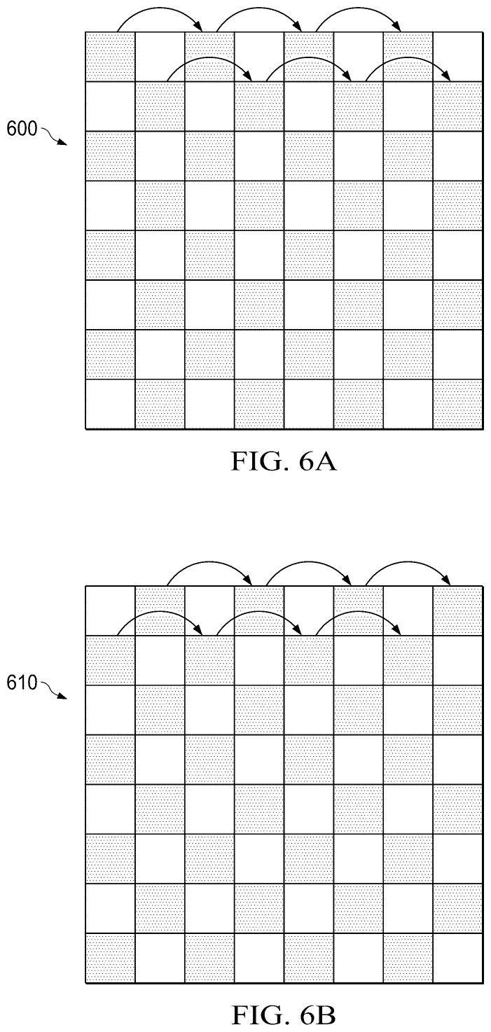

In some examples, the instructions, when executed, cause the processor to perform the color palette cluster analysis by: skipping color palette cluster analysis for portions of the image below a threshold luminance value; using a traversal LUT to determine an order for adding pixels of the image to the color palette cluster analysis (e.g., adding pixels based on the traversal pattern described in FIGS. 6A and 6B, or another skipping pattern); and using a pixel weight LUT to weight pixels added to the color palette cluster analysis. In some examples, the instructions, when executed, cause the processor to selectively disable overlap averaging analysis responsive to a control signal.

FIG. 2 is a block diagram of a controller 200 in accordance with various examples. The controller 200 is an example of the controller 102 in FIGS. 1A and 1B. In the example of FIG. 2, the controller 200 has a first terminal 202 and a second terminal 203. The first terminal 202 is an example of the first terminal 104 in FIGS. 1A and 1B. The second terminal 203 is an example of the fourth terminal 109 in FIGS. 1A and 1B. In the example of FIG. 2, image compression is performed external to controller 200.

In the example of FIG. 2, the controller 200 includes frame memory 206, a decompression block 212, a de-gamma block 218, a dither algorithm block 222, and a spatial light modulator (SLM) formatter block 228. In some examples, the frame memory 206 is an example of at least some of the memory 112 in FIGS. 1A and 1B. In some examples, the dither algorithm block 222 is a three-dimensional (3D) dither algorithm block. In the example of FIG. 2, the controller 200 receives compressed gamma-companded data 204 at the first terminal 202 and provides bit plane data 234 at the second terminal 203. As used herein, “gamma-companded data” refers to encoded image data that accounts for human perception of light and color, where the gamma encoding is compressed. In other words, the compressed gamma-companded data 204 included compression based on overlapped-block cluster compression as described herein and gamma compression. As used herein, “bit plane data” refers to one type of data provided to a spatial light modulator to set the pixel elements to an on state or an off-state. Another type of data provided to a spatial light modulator includes pulse-width modulation (PWM) signals. In some examples, a spatial light modulator may only have an on state and an off state, and no intermediate state for shading. The on/off control data is time multiplexed into bit planes, where the bit planes are displayed for varying times responsive to the PWM signals, with the least significant bit being the shortest and the most significant bit being the longest.

In some examples, the spatial light modulator 128 includes a Low Voltage Differential Signaling (LVDS) interface to receive control signals such as the bit plane data and the PWM signals. Without limitation, the spatial light modulator 128 may include micromirrors and a two-dimensional array of memory cells. The positive or negative deflection angle of the micromirrors can be individually controlled by changing the address voltage of underlying memory addressing circuitry and micromirror reset signals (MBRST). In some examples, the spatial light modulator 128 receives bit plane data and PWM signals through one or more LVDS input interfaces, responsive to the bit plane data and PWM signals, updates the mechanical state of the micromirrors.

In the example of FIG. 2, the frame memory 206 has a first terminal 208 and a second terminal 210. The decompression block 212 has first terminal 214 and a second terminal 216. The de-gamma block 218 has a first terminal 220 and a second terminal 221. The dither algorithm block 222 has a first terminal 224 and a second terminal 226. The SLM formatter block 228 has a first terminal 230 and a second terminal 232.

In the example of FIG. 2, the first terminal 208 of the frame memory 206 is coupled to the first terminal 202 of the controller 200. The second terminal 210 of the frame memory 206 is coupled to the first terminal 214 of the decompression block 212. The second terminal 216 of the decompression block 212 is coupled to first terminal 220 of the de-gamma block 218. The second terminal 221 of the de-gamma block 218 is coupled to the first terminal 224 of the dither algorithm block 222. The second terminal 226 of the dither algorithm block 222 is coupled to the first terminal 230 of the SLM formatter block 228. The second terminal 232 of the SLM formatter block 228 is coupled to the second terminal 203 of the controller 200.

In some examples, each of the frame memory 206, the decompression block 212, the de-gamma block 218, the dither algorithm block 222, and the SLM formatter block 228 is a separate hardware component. In other examples, the frame memory 206, the decompression block 212, the de-gamma block 218, the dither algorithm block 222, and the SLM formatter block 228 represent software modules, data and/or instructions stored in memory (e.g., the memory 112 in FIGS. 1A and 1B) and executable by a processor (e.g., the processor 110 in FIGS. 1A and 1B).

In FIG. 2, the frame memory 206 has a write side and a read side. The write side of the frame memory 206 relates to the gamma-companded data 204. In some examples, the write side of the frame memory 206 has a video frame rate of 240 Hz or less. The read side of the frame memory 206 relates to the decompression block 212, the de-gamma block 218, the dither algorithm block 222, and the SLM formatter block 228, and the bit plane data 234. In some examples, the read side of the frame memory 206 has a bit plane rate of 10 kHz or more.

In some examples, the controller 200 is configured to perform some or all of the operations described for the controller 102 of FIG. 1A, the compression circuit 152 of FIG. 1B, or the controller 162 of FIG. 1B. In such examples, the controller 200 may include additional components (e.g., the processor 110 and the memory 112 in FIGS. 1A and 1B) to perform overlapped-block cluster compression operations as described herein and obtain the compressed gamma-companded data 204 internally. In addition to such compression operations, the controller 200 may perform storage, decompression and SLM formatting operations. In other examples, the controller 200 may perform storage, decompression and SLM formatting operations, while another circuit or IC performs the compression operations described herein. In some examples, storage, decompression, and SLM formatting operations of the controller 200 are performed by the frame memory 206, the decompression block 212, the de-gamma block 218, the dither algorithm block 222, and the SLM formatter block 228.

More specifically, the frame memory 206 operates to receive the compressed gamma-companded data 204 at the first terminal 208. Again, the compressed gamma-companded data 204 may be obtained internally or from another circuit or IC using overlapped-block cluster compression as described herein. The compressed gamma-companded data 204 received at the first terminal 208 is stored by the frame memory 206 using available memory addressing and write operations. Upon request or based on a schedule/data rate, read operations are used to retrieve the stored compressed gamma-companded data 204 from memory and provide the compression results to the second terminal 210. As previously noted, write rates to and read rates from the frame memory 206 may differ.

The decompression block 212 operates to: receive the compressed gamma-companded data 204 at its first terminal 214 at a read rate of the frame memory 206; perform decompression operations on the compressed gamma-companded data 204 to partially or fully reverse the overlapped-block cluster compression described herein (e.g., use 30 bpp instead of 11 bpp for colors); and output first decompression result at the second terminal 216. The de-gamma block 218 operates to: receive the first decompression results at the first terminal 220; apply de-gamma operations that partially or fully reverse the gamma compression of the compressed gamma-companded data 204, resulting in second decompression results; and provide the second decompression results at the second terminal 221. In some examples, gamma encoding applies an Opto-Electronic Transfer Function (OETF) that accounts for differences in human discernment darker shades versus brighter shades. In some examples, gamma encoding is compressed before storage (e.g., before storing related compression results, such as the compressed gamma-companded data 204, are written to the frame memory 206) and is decompressed after retrieval from storage (e.g., after related compression results, such as the compressed gamma-companded data 204, are read from the frame memory 206).

The dither algorithm block 222 operates to: receive the second decompression results at the first terminal 224; apply dithering (random noise) to the second decompression results to obtain dithered decompression results; and provide dithered decompression results at the second terminal 226. In some examples, the dithering operations performed by the dither algorithm block 222 applies random noise to the second decompression results to reduce the effect of quantization error in the second decompression results. The SLM formatter block 228 operates to: receive the dithered decompression results at the first terminal 230; provide CS2 at the second terminal 232 based on the dithered decompression results and an SLM format. In some examples, CS2 may include the bit plane data 234, PWM signals, control voltages, and/or other signals as previously described.

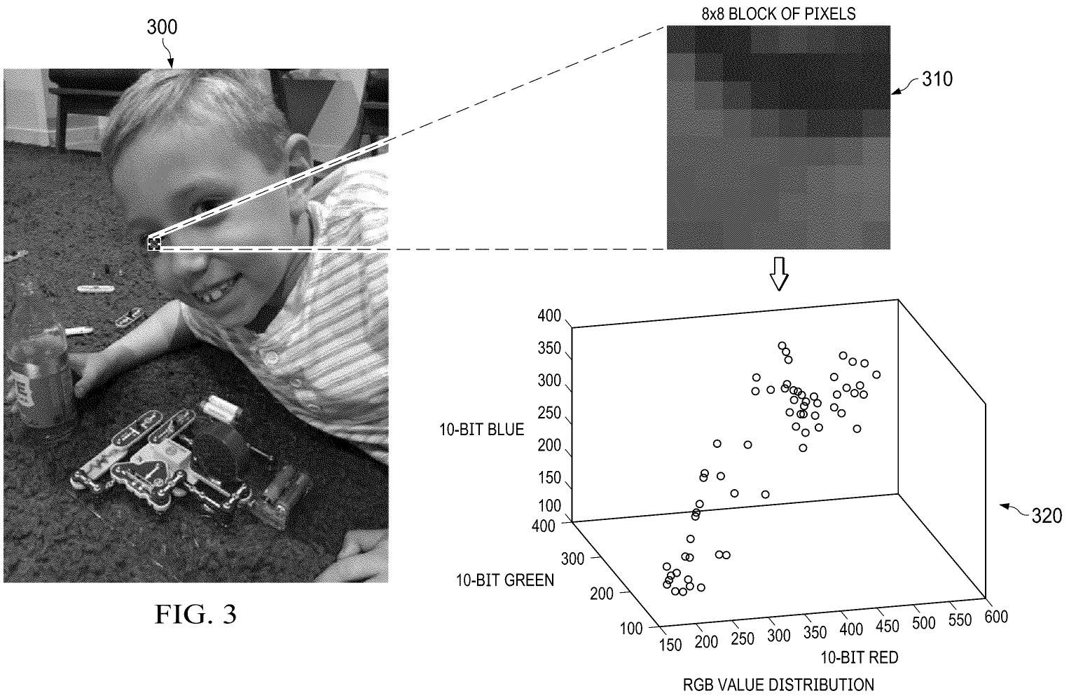

FIGS. 3 to 9 describe example cluster compression and related operations that may be performed as part of the overlapped-block cluster compression described at least in FIGS. 1A, 1B, and 2. FIGS. 10 to 12 describe example overlapped-block averaging and related operations that may be performed as part of the overlapped-block cluster compression described at least in FIGS. 1A, 1B, and 2. FIG. 3 is an image 300 and related sub-block 310 and graph 320 of RGB value distribution in accordance with various examples. In some examples, the image 300 is a raw image file with 30 bits per pixel. In some examples, the image 300 may be part of a video input to the controller 102 in FIG. 1A, the compression circuit 152 in FIG. 1B, or the controller 162 in FIG. 1B. The example sub-block 310 of the image 300 is an 8×8 block of pixels that is used to demonstrate compression herein. The sub-block 310 is a closeup of an eye in the image 300 and is composed of 8 rows and 8 columns, or 64 pixels. The graph 320 shows an RGB value distribution for the 64 pixels of the sub-block 310 graphed on the x, y, and z-axes of the three-dimensional RGB. In the example of FIG. 3, each of the red axis, the green axis, and the blue axis is a 10-bit axis. In some examples, compression is a block-based compression algorithm, where the related blocks or sub-blocks can be any size. Without limitation, the sub-block 310 is an 8×8 sub-block. While the image 300 in FIG. 3 appears herein as a black and white image, the original image that makes up FIG. 3 is a color image, and it is the color image that is compressed using the compression options described herein. For simplicity, only some of pixels of the sub-block 310 are represented in graph 320, rather than all 64 pixels. However, the techniques described herein may operate on all pixels of a sub-block, such as the sub-block 310.

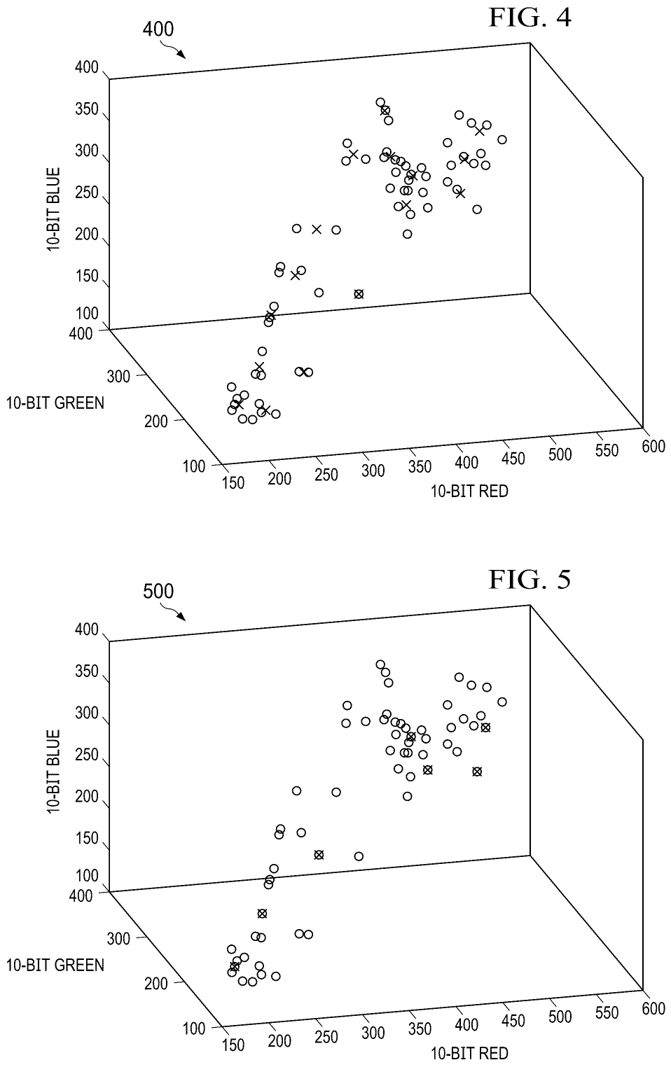

FIG. 4 is a graph 400 of RGB values and final cluster centroid results in accordance with various examples. The graph 400 shows the RGB values of the graph 320 of FIG. 3 (as circles) along with final cluster centroid results (each “x”). In FIG. 4, the final cluster centroid results are obtained by performing cluster compression operations related to the overlapped-block cluster compression described herein. In the example of FIG. 4, cluster compression reduces the number of RGB values used to represent colors in graph 320 (e.g., up to 64 RGB values in an 8×8 sub-block are reduced to 16 RGB values). In different examples, the selection of clusters and their respective centroids and the number of operations used to obtain cluster centroid results may vary. In other words, different cluster compression options vary with regard to their relative speed, the relative number of operations performed, the relative amount of memory used, and the number of final cluster centroid results. In some examples, overlapped-block cluster compression may be expedited relative to other cluster compression techniques based on luminance sorting to select a target number of initial centroid values.

In some examples, the final cluster centroid results related for RGB values of graph 320 are determined by: obtaining an image or related sub-block; and performing color palette cluster analysis on an initial set of colors of the image or sub-block (e.g., the RGB values in graph 320 of FIG. 3, or the RGB values in graph 400 in FIG. 4), luminance sorting, and a target number of palettes. For color palette cluster analysis, each final cluster centroid result corresponds to a palette. The luminance sorting described herein is one way to initialize clusters and centroids of an image or sub-block. Once clusters and related centroids of an image or sub-block are initialized based on luminance sorting, additional cluster compression operations are used to refine the clusters and centroids until a target number of centroids (RGB palettes) is reached, resulting in final cluster centroid results. If the number of final cluster centroids is greater than the number of initial cluster centroids, refining the clusters and centroids includes splitting clusters and assigning or reassigning RGB values to a nearest cluster centroid.

In some examples, luminance sorting includes: obtaining the RGB values in the graph 320; converting each of the RGB values to a respective luminance value; and sorting the luminance values (e.g., from lowest to highest or vice versa) to obtain a sorted index of luminance values. During cluster compression operations, the process of luminance sorting and cluster/centroid initialization is performed for each sub-block of an image. In some examples, cluster compression may simplify or bypass clustering operations for sub-blocks with luminance variance below a threshold (indicating all RGB values of a sub-block have about the same luminance value). In some examples, color palette cluster analysis is initialized by selecting a target number of distributed luminance values in the sorted index as initial centroids. Additional details and options for how final cluster centroid results, such as those shown in graph 400, are determined are provided in the figures and description hereafter.

FIG. 5 is a graph 500 of RGB values and cluster initialization based on luminance sorting in accordance with various examples. The graph 500 shows the RGB values of the graph 320 of FIG. 3 (as circles) along with initial cluster centroids (each “x”) based on luminance sorting. In some examples, luminance sorting operations include: obtaining RGB values of an image or related sub-block; converting each RGB value to a luminance value; and sorting the luminance values to obtain a sorted index of luminance values. In some examples, each RGB value of the graph 320 has a first number of bits and each luminance value has a second number of bits, where the second number of bits being less than the first number of bits. With luminance sorting, the number of bits that are analyzed to perform initial clustering is simplified compared to sorting initial RGB values. Other luminance sorting operations may include: partitioning the sorted index of luminance values into a target number of bins; selecting center values for the bins; and initializing the color palette cluster analysis responsive to each of the center values. Grouping sorted luminance values into a target number of bins and selecting centers values for the bins as initial centroids is one way to initialize color palette cluster analysis. In some examples, the bins have the same number of sorted luminance values and the center values for respective bins has RGB values corresponding to colors of the initial set of colors.

In other examples, the number of sorted luminance values in each of the bins may vary (e.g., if equal distribution is not possible, unequal distribution may be used). Also, in some examples, an average RGB value for each bin may be used instead of selecting a center RGB value. In FIG. 5, the initial cluster centroids of graph 500 correspond to the center values for each of the bins. In some examples, each of the RGB values in the graph 320 is a 30-bit RGB value. In such examples, each 30-bit RGB value may be converted to a luminance value with fewer bits (e.g., a 14-bit luminance value) to simplify sorting analysis. The luminance values are then sorted in ascending or descending order and may be stored as an index. In some examples, the sorted luminance values are partitioned into a target number of equally spaced bins (e.g., 7 bins or another number of bins). If possible, each bin has the same number of luminance values. In some examples, the center value of each bin is selected as an initial centroid. As an example, if there are 61 unique luminance values and 7 bins, each bin will include 8.7 pixels. In some examples, the average value of each bin may be used as an initial centroid for each cluster.

Using luminance sorting to initialize a target number of centroids for overlapped-block cluster compression and related color palette cluster analysis is one way to reduce the overall number of calculations when performing overlapped-block cluster compression. A reduction in the overall number of calculations provides the benefits of reduced latency and reduced power consumption. It is possible, for example, to initialize cluster compression with a single centroid, RGB value, or luminance value. In such examples, initializing color palette cluster analysis is expedited compared to the luminance sorting technique described herein, but the number of iterations needed and the overall number of calculations performed to obtain the target number of color palettes (e.g., 16 color palettes) is increased.

FIGS. 6A and 6B are diagrams 600 and 610 showing sub-block traversal during cluster compression in accordance with various examples. In the example diagram 600 of FIG. 6A, sub-block traversal starts in the upper left corner of a sub-block and proceeds in a skipping pattern that skips each adjacent sub-block to the right of a sub-block whose pixel or pixels are added to the cluster compression analysis. The same traversal process continues until skipping is not possible due to there being no more sub-blocks or only one more sub-block in the row being traversed. For example, after the top row of diagram 600 is traversed, the traversal process and related skipping pattern continues on the next row of diagram 600 as shown. After the second row, the traversal process and skipping pattern would continue on the third row, and so on.

In the example diagram 610 of FIG. 6B, sub-block traversal starts in the sub-block to the right of the upper left corner and proceeds in a skipping pattern that skips each adjacent sub-block. The same traversal process continues until skipping is not possible due to there being no more sub-blocks or only one more sub-block in the row being traversed. For example, after the top row of diagram 610 is traversed, the traversal process and related skipping pattern continues on the next row of diagram 610 as shown. After the second row, the traversal process and skipping pattern would continue on the third row, and so on. In different examples, the sub-block traversal pattern may vary. In these different examples, programmable hardware may support one or more traversal patterns that includes jumping or skipping rather than a simple a raster scan (e.g., top to bottom and left to right). The described transversal pattern avoids clumping or bias early in the iterative process.

During traversal, a nearest cluster is determined for the RGB value(s) of the pixel or pixels of each sub-block being considered. In some examples, a nearest cluster is determined using a minimum summed weighted squared distance metric (SDM). In some examples, a minimum summed weighted SDM is based on:

$${R}_{diff} = abs ( {R}_{centroid} - {R}_{pixel} ) , \qquad Equation ( 1 )$$

$${G}_{diff} = abs ( {G}_{centroid} - {G}_{pixel} ) , \qquad Equation ( 2 )$$

$${B}_{diff} = abs ( {B}_{centroid} - {B}_{pixel} ) , and \qquad Equation ( 3 )$$

$$SDM = {R}_{weight} * {R}_{diff}^{2} + {G}_{weight} * {G}_{diff}^{2} + {B}_{weight} * {B}_{diff}^{2} . \qquad Equation ( 4 )$$

In equation (1), abs(R_{centroid}−Rₚᵢₓₑₗ) is a red absolute difference sum and R_{diff} is the related red difference or distance metric of a pixel's red value relative to a centroid's red value. In equation (2), abs(G_{centroid}−Gₚᵢₓₑₗ) is a green absolute difference sum and G_{diff} is the related green difference or distance metric of a pixel's green value relative to a centroid's green value. In equation (3), abs(B_{centroid}−Bₚᵢₓₑₗ) is a blue absolute difference sum and B_{diff} is the related blue difference or distance metric of a pixel's blue value relative to a centroid's blue value. In equation (4), R_{weight} is a red weighting, G_{weight} is a green weighting, and B_{weight} is a blue weighting. As sub-blocks and/or pixels are added to the cluster compression analysis, the cluster centroids are recursively adjusted.

In some examples, pixels added to the cluster compression analysis are added in a spatially diverse manner, such as the traversal option described in diagrams 600 and 610 in FIGS. 6A and 6B. Other spatially high frequency options are possible. For example, the starting point and/or the distance between sub-blocks or pixels added to the cluster compression analysis may vary.

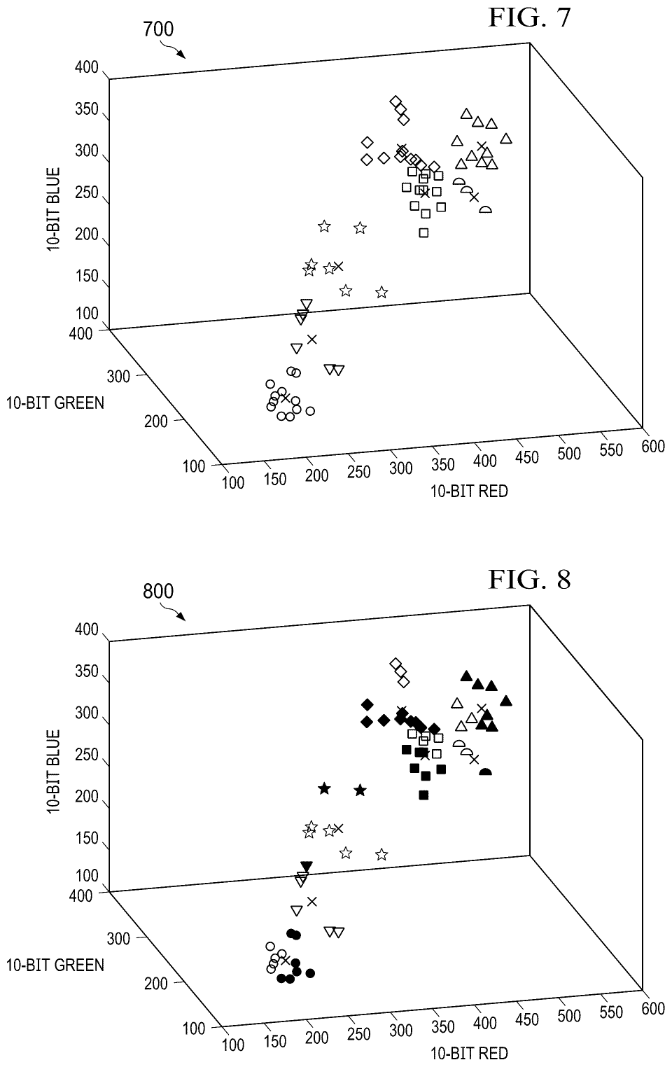

FIG. 7 is a graph 700 of clusters and related centroids in accordance with various examples. During cluster compression analysis, the RGB values for pixels of an image or sub-block are added to a nearest cluster based on the location of the initial cluster centroids. As more pixels of the image or sub-block are added to the color palette cluster analysis, the number of pixels in each cluster changes as needed, and the centroid of each cluster is shifted to minimize the cumulative variance between the centroid and the pixels of the respective cluster. In the example of FIG. 7, the initial cluster centroids shown and described for graph 500, have been shifted in graph 700 and no longer represent any of the initial RGB values. Instead, the cluster centroids of graph 700 have been calculated to minimize the cumulative variance between each cluster centroid and the pixels of the respective cluster. In graph 700, RGB values are organized into seven clusters, and each cluster has a related centroid. The RGB values of a first cluster are shown using circles. The RGB values of a second cluster are shown using first triangles (point down). The RGB values of a third cluster are shown using stars. The RGB values of a fourth cluster are shown using squares. The RGB values of a fifth cluster are shown using half-circles. The RGB values of a sixth cluster are shown using diamonds. The RGB values of a seventh cluster are shown using second triangles (point up). Each of the centroids is shown using an “x”.

In some examples, an update algorithm, similar to a least means square (LMS) algorithm, is used for cluster compression operations to minimize compute load. In some examples, if n=number of pixels assigned to a centroid, then n_{quant}=n quantized to a power of 2 value (1, 2, 4, 8, 16, . . . , 1024). If (n_{quant}==n), then Sₙ=Sₙ₋₁+xₙ, μₙ=Sₙ/n, else μₙ=μₙ₋₁+(xₙ−μₙ₋₁)/n_{quant}. In some examples, μₙ=Sₙ/n is accomplished with a simple binary shift since n is a power of 2. Also, μₙ=μₙ₋₁+(xₙ−μₙ₋₁)/n_{quant} may be accomplished using a simple binary shift. During each iteration, divide estimates may be obtained, which reduces the number of dividers needed. At the end of an iterative loop, available dividers may be timeshared to perform true divides to correct the divide estimations as needed. In some examples, only 16 divides are performed per iteration. For comparison, another cluster compression technique performed 64 divides per iteration. In some examples, the minimum SDM for each pixel relative to the clusters is determined.

FIG. 8 is a graph 800 of split clusters during cluster compression in accordance with various examples. In the example of graph 800, each of the clusters shown in the graph 700 of FIG. 7 has been split into two clusters. In other words, the clusters of the graph 700 of FIG. 7 may be referred to as parent clusters, while the clusters of the graph 800 may be referred to as child clusters. In graph 800, the outline shapes are a first child cluster and the solid shapes are a second child cluster. The splitting process is referred to herein as parent-child cluster (PCC) compression.

In some examples, the procedure for assigning each of the pixels to a cluster is known as K-means clustering and operates as follows. First, for each pixel of the sub-block 310, PCC compression may begin by determining a distance to the nearest initial centroid. In different examples, any suitable type of distance function may be used. Example distance functions include a summed absolute difference function, a mean squared error function, a weighted summed absolute difference function, or any other suitable distance functions. In some examples, the nearest cluster is determined by finding the minimum summed weighted SDM between a given pixel and each of the centroids based on equations (1) to (4). The distance values are stored and are used to assign pixels to a nearest cluster. As each new pixel is added, the location of the nearest centroid is updated to account for the new pixel. The movement and final location of each centroid depends on how many pixels are assigned to the respective cluster and how spread out the pixels are in RGB space. As each pixel is assigned to a cluster, a size value is tracked for each cluster. The size values, size thresholds, cluster size comparisons, and/or a target number of color palettes may be used to split clusters until the target number of color palettes is reached.

As previously described, color palette cluster analysis may include initialization of a target number of centroids based on luminance sorting, and then clustering operations until a target number of color palettes is reached. In some examples, color palette cluster analysis includes PCC operations, where parent clusters are split into multiple child clusters as needed until the final centroid results (see e.g., FIG. 4) correspond to the target number of color palettes. In some examples, initialization based on luminance sorting results in a target number of centroids to start (e.g., 7 initial centroids) as described in FIG. 5. If the initial number of centroids is 7 and the target number of color palettes is 16 as described in FIG. 4, the 7 initial clusters (parent clusters) would need to be split until there are 16 clusters and related centroids. In some examples, cluster splitting is based on calculating a splitting improvement score (e.g., the parent SDM minus the average of its children's SDM) for each existing cluster. The splitting improvement scores may be sorted, for example, from largest to smallest. The cluster related to the largest splitting improvement score is then split, which increases the number of clusters and related centroids. The same process may be repeated until the target number of color palettes is reached. Also, the same process may be repeated for multiple iterations. In some examples, each iteration results in one or more parent clusters being split into two children. In some examples, 4 iterations is sufficient to split initial centroids (e.g., 7 or 8 initial centroids) into a target number of centroids (e.g., (16 centroids) for an 8×8 block. Without limitation, the same traversal pattern may be used for each iteration.

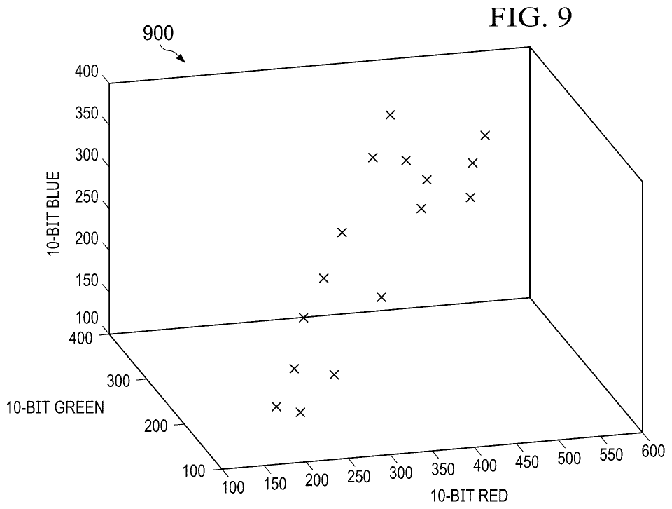

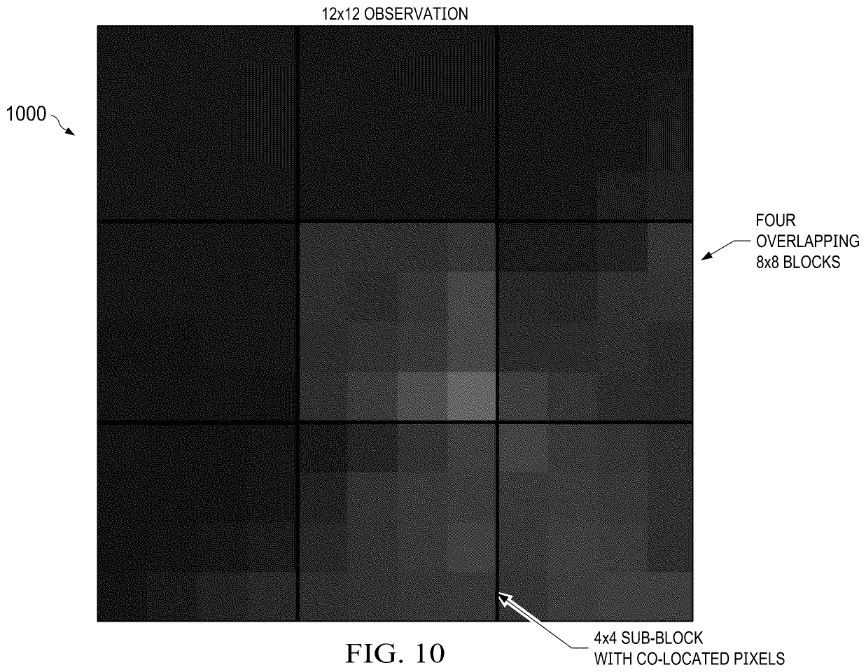

FIG. 9 is a graph 900 of cluster compression results in accordance with various examples. In graph 900, the cluster compression results include 16 cluster centroid results, which are RGB values obtained by the color palette cluster analysis described in FIGS. 4 to 8. The 16 cluster centroid results of FIG. 9 are the same as the cluster centroid results in FIG. 4. In FIG. 9, the cluster centroid results are more visibly without the related pixel RGB values shown in FIG. 4. In some examples, the cluster centroid results may be used for compression operations, where the RGB value of each pixel of an original image is replaced by the RGB value of a nearest cluster centroid result.

As previously noted, color palette cluster analysis may be performed for different sub-blocks of an image. In different examples, the size of the sub-blocks may vary. Also, in some examples, at least some of the sub-blocks for which color palette cluster analysis is performed may overlap. FIG. 10 is a diagram 1000 showing overlapping blocks and a resulting sub-block with co-located pixels in accordance with various examples. More specifically, the diagram 1000 represents four overlapping 8×8 blocks. The central 4×4 sub-block in diagram 1000 has co-located pixels from all four of the overlapping 8×8 blocks. In some examples, a block overlap of 50% is used. In other examples, the amount of overlap may vary. Along image edges, less block overlap or no block overlap is used.

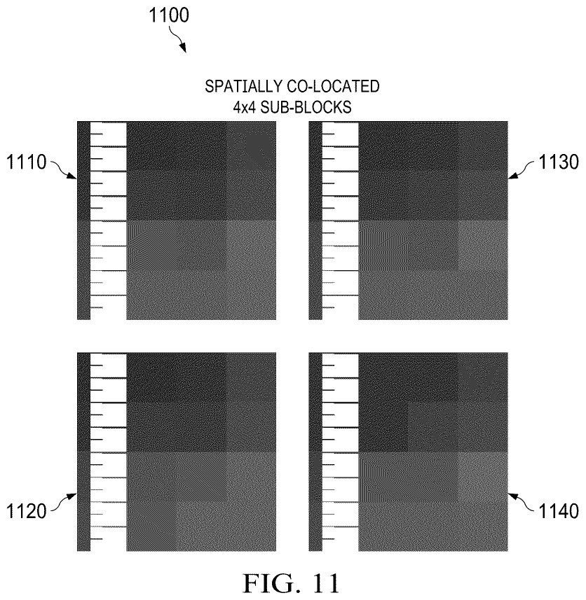

FIG. 11 is a diagram 1100 showing spatially co-located pixels in accordance with various examples. In the diagram 1100, four spatially co-located 4×4 sub-blocks 1110, 1120, 1130, and 1140 are represented. The spatially co-located 4×4 sub-blocks 1110, 1120, 1130, and 1140 correspond to the portion of each of the 8×8 blocks in central sub-block of the diagram 1000 of FIG. 10.

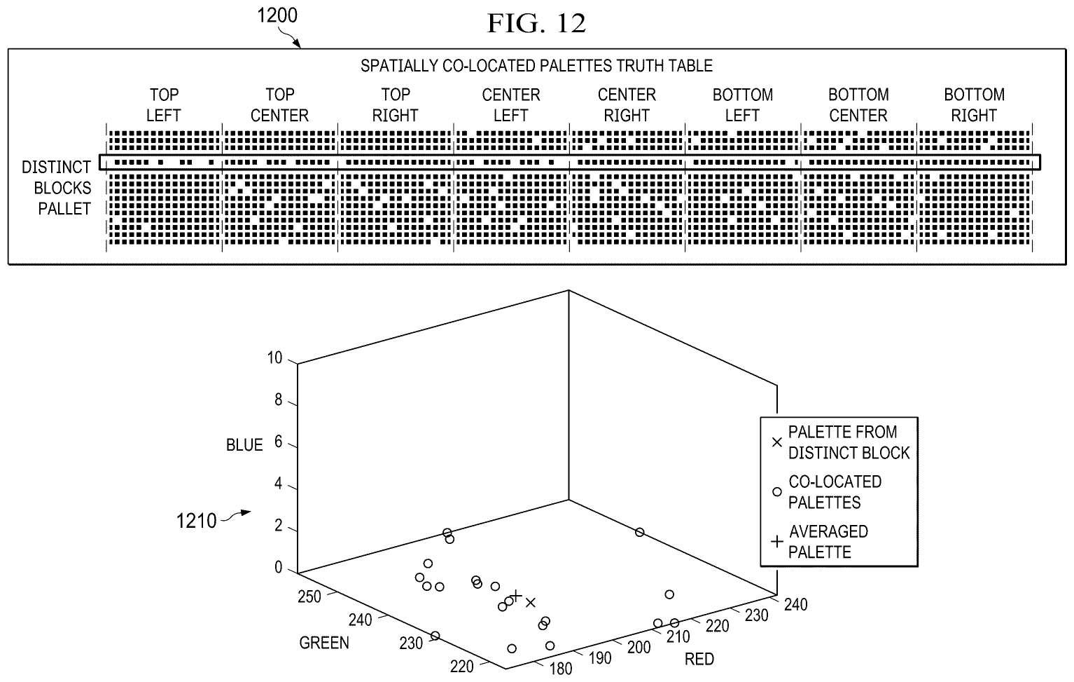

FIG. 12 is a spatially co-located palettes truth table 1200 and a related graph 1210 in accordance with various examples. The spatially co-located palettes truth table 1200 aggregates co-location results from the four 8×8 sub-blocks in FIG. 10 and describes which palettes from overlapping blocks share the same location with each of the 16 palettes of the central 4×4 sub-block in FIG. 10. The y-axis of the spatially co-located palettes truth table 1200 is the palette index for the central 4×4 sub-block in FIG. 10 (sometimes referred to as the “distinct block” herein) and includes 16 total palettes. The x-axis of the spatially co-located palettes truth table 1200 is the palette index for the four overlapping 8×8 sub-blocks in FIG. 10. The highlighted row in FIG. 12 corresponds to the 5^{th} palette of the distinct block. For example, in the highlighted row, palette entries 1, 7, 9, 10, 13, 14, and 16 from the top left block in FIG. 10 are shown to be spatially co-located with the 5^{th} palette entry of the distinct block, the palette entries 6, 10, and 16 of the top center block in FIG. 10 are shown to spatially co-located with the 5^{th} palette entry of the distinct block, and so on. Once spatially co-located palettes are determined, averaging of those palettes is performed. In the example of FIG. 12, the 5^{th} palette entry of the distinct block corresponding to the highlighted row of the spatially co-located palettes truth table 1200 may be replaced with the average of co-located palettes as represented with graph 1210.

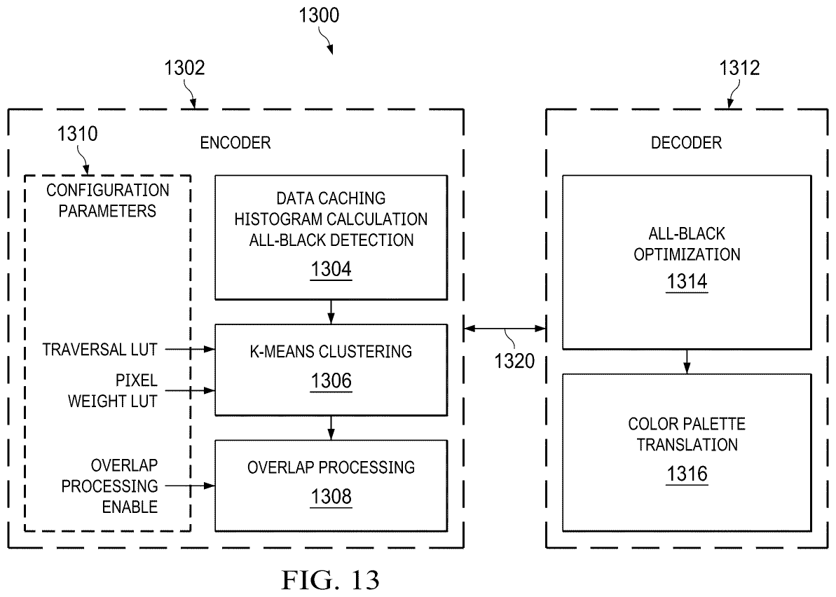

FIG. 13 is a block diagram of a processing system 1300 in accordance with various examples. As shown, the processing system 1300 includes an encoder 1302 and a decoder 1312. The processing system 1300 may also include a communication interface 1320 between encoder 1302 and the decoder 1312. In other examples, the communication interface 1320 is an example of an internal communication interface of the controller 102 in FIG. 1. In other examples, the communication interface 1320 is an example of the interface 170 in FIG. 1B. In some examples, the controller 102 of FIG. 1A includes the encoder 1302 and the decoder 1312. In other examples, the compression circuit 152 of FIG. 1B includes the encoder 1302, while the controller 162 of FIG. 1B includes the decoder 1312. In some examples, the controller 200 includes the decoder 1312, while another circuit or IC (e.g., the controller 102 in FIG. 1A, or the compression circuit 152 in FIG. 1B) includes the encoder 1302.

In the example of FIG. 13, the encoder 1302 performs data caching, histogram calculation, and all-black detection operations 1304, K-means clustering operations 1306, and overlap processing operations 1308. During the K-means clustering operations 1306 and the overlap processing operations 1308, configuration parameters 1310 of the encoder 1302 may be used. In some examples, the configuration parameters 1310 include a traversal LUT and a pixel weight LUT. The traversal LUT applies a traversal pattern when adding pixels to the K-means clustering operations 1306 (sometimes referred to as color palette cluster analysis herein). The traversal pattern of FIGS. 6A and 6B is one example of the results of applying the traversal LUT. In some examples, the pixel weight LUT provides the R_{weight}, G_{weight}, and B_{weight} values used in equation (4). In some examples, the configuration parameters 1310 include an overlap processing enable feature or signal. When the overlap processing enable feature or signal is “on” or asserted, the overlap processing operations 1308 are performed. FIGS. 10 to 12 describe example overlap processing options (sometimes referred to overlapped-block operations or overlap averaging operations herein). When the overlap processing enable feature or signal is “off” or de-asserted, the overlap processing operations 1308 are not performed. In some examples, the overlap processing enable feature or signal may be controlled to save power (disable) or may be omitted.

In some examples, the data caching, histogram calculation, and all-black detection operations 1304 include a data caching portion to store pixel data processed during the K-means clustering operations 1306. The histogram calculation portion includes the luminance sorting operations described herein. The all-black detection portion includes detecting sub-blocks or pixels with a luminance value below a threshold and omitting these sub-blocks or pixels from the K-means clusters operations 1306. In some examples, the K-means clustering operations 1306 include initialization based on luminance sorting, the color palette cluster analysis options described herein, PCC compression options, etc. The overlap processing operations 1308 include the overlapped-block analysis operations described herein.

In some examples, the decoder 1312 perform all-black optimization operations 1314 and color palette translation operations 1316. The all-black optimization operations 1314 uses an all-black flag or indicator provided by the encoder 1302 to perform power-saving optimizations. As an example, the power-saving optimizations may reduce read/write traffic to the frame memory 206 in FIG. 2. The color palette translation operations 1316 convert colors of a compressed set of color palettes to a target set of color palettes. In some examples, the color palette translation operations 1316 convert a 4-bit value (e.g., assuming 16 colors in the compressed set of a color palette keys) to a 30-bit value.

In some examples, a system includes: an encoder (e.g., the encoder 1302 in FIG. 13); a decoder (e.g., the decoder 1312 in FIG. 13) coupled to the encoder; and a spatial light modulator (e.g., the spatial light modulator 128 in FIGS. 1A and 1B) coupled to the decoder. The encoder performs the overlapped-block cluster compression described herein to obtain compression results. In some examples, the encoder corresponds to encoding components of the controller 102 in FIG. 1A, encoding components of the compression circuit 152 in FIG. 1B, or encoding components of the controller 162 in FIG. 1B. The decoder performs storage of the compression results and prepares control signals (e.g., CS2) for a spatial light modulator based on the compression results. In some examples, the decoder includes decoding components of the controller 162 in FIG. 1B, decoding components of the controller 162, or decoding components of the controller 200 in FIG. 2.

In some examples, the encoder is configured to: obtain an image; perform color palette cluster analysis on the image based on an initial set of colors, luminance sorting, and a target number of palettes; produce a compressed set of color palette keys responsive to the color palette cluster analysis; for a plurality of sub-blocks of the image, adjust the compressed set of color palette keys responsive to an overlap averaging analysis to produce an adjusted set of palette keys; and output a compressed image based on the adjusted set of palette keys. The decoder is configured to: receive the compressed image; and produce output data based on the compressed image. The spatial light modulator is configured to: receive the output data; and display a displayed image based on the output data.

In some examples, the encoder is further configured to perform the luminance sorting by: obtaining an RGB value for each color of the initial set of colors; converting each RGB value to a luminance value; sorting the luminance values to obtain a sorted index of luminance values; partitioning the sorted index of luminance values into a target number of bins; selecting center values for the bins; and initializing the color palette cluster analysis responsive to each of the center values. In some examples, the bins have the same number of sorted luminance values, the center values for respective bins have RGB values corresponding to colors of the initial set of colors, and the frame buffer data is decompressed relative to the compressed image.

In some examples, the encoder is configured to perform the color palette cluster analysis for each sub-block by: adding pixels to the color palette cluster analysis based on a spatial pattern that skips over adjacent pixels; adjusting cluster centroids responsive to each pixel being added; performing a target number of clustering iterations; for each clustering iteration, obtaining a set of color palette keys; and, for each clustering iteration, dividing the set of color palette keys based on the target number of palettes. In some examples, the encoder is configured to perform the overlap averaging analysis by: obtaining the compressed set of color palette keys for each of the sub-blocks; identifying co-located pixels of the sub-blocks; and, for each co-located pixel, averaging the compressed set of color palette keys to obtain the adjusted set of palette keys.

In some examples, the encoder is part of a first integrated circuit and the decoder is part of a second integrated circuit separate from the first integrated circuit. In some examples, the encoder and the decoder are parts of a single integrated circuit.

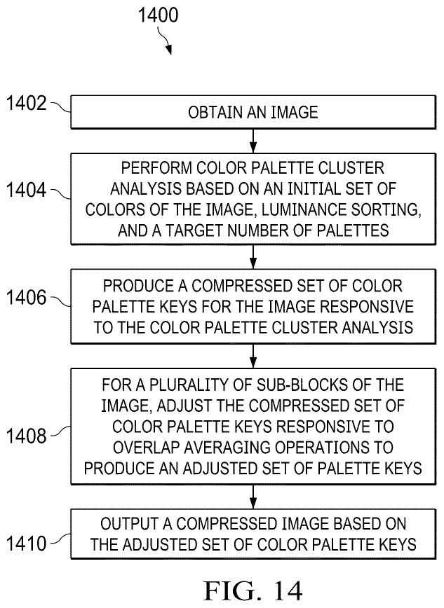

FIG. 14 is a method 1400 in accordance with various examples. The method 1400 is performed by a processing device such as the controller 102 of FIG. 1, the processor 110 in FIGS. 1A and 1B, or the compression circuit 152 in FIG. 1B. As shown, the method 1400 includes obtaining an image at block 1402. At block 1404, color palette cluster analysis is performed based on an initial set of colors of the image, sorted luminance values, and a target number of palettes. At block 1406, a compressed set of color palette keys is provided responsive to the color palette cluster analysis. At block 1408, the compressed set of color palette keys is adjusted, for each of a plurality of sub-blocks of the image, responsive to overlap averaging operations. At block 1410, a compressed image is output based on the adjusted set of color palette keys.

In some examples, the method 1400 includes performing overlapped-block cluster compression as described herein. In some examples, overlapped-block cluster compression operations include: obtaining an image; performing color palette cluster analysis for a plurality of sub-blocks of the image, the plurality of sub-blocks including sub-blocks with co-located pixels; providing a compressed set of color palette keys for each sub-block of the image responsive to the color palette cluster analysis; averaging respective color palette keys of the compressed set of color palette keys for each co-located pixel to obtain an adjusted set of color palette keys; and outputting a compressed image based on the adjusted set of color palette keys.

In some examples, initial centroids for the color palette cluster analysis are determined based on luminance sorting (sorted luminance values). In such examples, the method 1400 may perform luminance sorting by: obtaining an RGB value for an initial set of colors of the image; converting each RGB value to a luminance value; sorting the luminance values to obtain a sorted index of luminance values; partitioning the sorted index of luminance values into a target number of bins; selecting center values for the bins; and initializing the color palette cluster analysis responsive to each of the center values. In some examples, the color palette cluster analysis of the method 1400 may include: skipping the color palette cluster analysis for portions of the image below a threshold luminance value; using a skipping pattern when adding pixels of the image to the color palette cluster analysis; and weighting pixels added to the color palette cluster analysis.

With the method 1400, the pixels of an image are replaced with cluster centroids as described herein. Replacing the pixels of an image with cluster centroids is a first compression option to produce a compressed image. Any suitable type of display can be used to display the compressed image. Example displays that may include the light source 120 and the spatial light modulator 128 of FIGS. 1A and 1B include a digital micromirror device (DMD) display, a liquid crystal display (LCD), a light emitting diode (LED) display, a thin-film transistor (TFT) display, a liquid crystal on silicon (LCoS) display, or any other display. As another option, the compressed image may be decompressed before display, where compression is used to reduce the memory footprint and/or the bandwidth overhead of display operations.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

1. An apparatus comprising:
a processor; and
memory coupled to or included with the processor, the memory storing instructions that, when executed, cause the processor to:
obtain an image;
perform color palette cluster analysis on the image based on an initial set of colors, luminance sorting, and a target number of palettes;
produce a compressed set of color palette keys responsive to the color palette cluster analysis; and
output a compressed image based on the compressed set of color palette keys.

2. The apparatus of claim 1, wherein the instructions, when executed, further cause the processor to perform the luminance sorting by:
obtaining a red-green-blue (RGB) value for each color of the initial set of colors;
converting each RGB value to a luminance value, each RGB value having a first number of bits, each luminance value having a second number of bits, the second number of bits being less than the first number of bits; and
sorting the luminance values to obtain a sorted index of luminance values.

3. The apparatus of claim 2, wherein the instructions, when executed, further cause the processor to perform the luminance sorting by:
partitioning the sorted index of luminance values into a target number of bins;
selecting center values for the bins; and
initializing the color palette cluster analysis responsive to each of the center values.

4. The apparatus of claim 3, wherein the bins have the same number of sorted luminance values and the center values for respective bins have RGB values corresponding to colors of the initial set of colors.

5. The apparatus of claim 1, wherein the instructions, when executed, cause the processor to perform the luminance sorting and the color palette cluster analysis, the color palette cluster analysis including:
adding pixels to the color palette cluster analysis based on a spatial pattern that skips over adjacent pixels; and
adjusting cluster centroids responsive to each pixel being added.

6. The apparatus of claim 1, wherein the instructions, when executed, cause the processor to perform the color palette cluster analysis for each sub-block by:
performing a target number of clustering iterations;
for each clustering iteration, obtaining a set of color palette keys; and
for each clustering iteration, dividing the set of color palette keys based on the target number of palettes.

7. The apparatus of claim 1, wherein the instructions, when executed, cause the processor to:
adjust the compressed set of color palette keys, for each of a plurality of sub-blocks of the image, responsive to an overlap averaging analysis, to produce an adjusted set of color palette keys; and
output the compressed image based on the adjusted set of color palette keys.

8. The apparatus of claim 7, wherein the overlap averaging analysis includes:
obtaining the compressed set of color palette keys for each of the plurality of sub-blocks of the image;
identifying co-located pixels of the plurality of sub-blocks; and
for each co-located pixel, averaging respective color palette keys of the compressed set of color palette keys to obtain an adjusted set of color palette keys.

9. The apparatus of claim 8, wherein the instructions, when executed, further cause the processor to identify the co-located pixels of the sub-blocks based on truth table analysis.

10. The apparatus of claim 1, wherein the instructions, when executed, cause the processor to perform the color palette cluster analysis by:
skipping the color palette cluster analysis for portions of the image below a threshold luminance value;
using a traversal look-up table (LUT) to determine an order for adding pixels of the image to the color palette cluster analysis; and
using a pixel weight LUT to weight pixels added to the color palette cluster analysis.

11. A system comprising:
an encoder configured to:
obtain an image;
perform color palette cluster analysis on the image based on an initial set of colors, luminance sorting, and a target number of palettes;
produce a compressed set of color palette keys responsive to the color palette cluster analysis;
for a plurality of sub-blocks of the image, adjust the compressed set of color palette keys responsive to an overlap averaging analysis to produce an adjusted set of palette keys; and
output a compressed image based on the adjusted set of palette keys;
a decoder coupled to the encoder, the decoder configured to:
receive the compressed image; and
produce output data based on the compressed image; and
a spatial light modulator coupled to the decoder, the spatial light modulator configured to:
receive the output data; and
display a displayed image based on the output data.

12. The system of claim 11, wherein the encoder is further configured to perform the luminance sorting by:
obtaining a red-green-blue (RGB) value for each color of the initial set of colors;
converting each RGB value to a luminance value;
sorting the luminance values to obtain a sorted index of luminance values;
partitioning the sorted index of luminance values into a target number of bins;
selecting center values for the bins; and
initializing the color palette cluster analysis responsive to each of the center values.

13. The system of claim 11, wherein the encoder is further configured to perform the color palette cluster analysis for each sub-block by:
adding pixels to the color palette cluster analysis based on a spatial pattern that skips over adjacent pixels;
adjusting cluster centroids responsive to each pixel being added;
performing a target number of clustering iterations;
for each clustering iteration, obtaining a set of color palette keys; and
for each clustering iteration, dividing the set of color palette keys based on the target number of palettes.

14. The system of claim 11, wherein the encoder is further configured to perform the overlap averaging analysis by:
obtaining the compressed set of color palette keys for each of the sub-blocks;
identifying co-located pixels of the sub-blocks; and
for each co-located pixel, averaging the compressed set of color palette keys to obtain the adjusted set of palette keys.

15. The system of claim 11, wherein the encoder is part of a first integrated circuit and the decoder is part of a second integrated circuit separate from the first integrated circuit.

16. The system of claim 11, wherein the encoder and the decoder are parts of a single integrated circuit.

17. A method comprising:
obtaining, by a processing device, an image;
performing, by the processing device, color palette cluster analysis for a plurality of sub-blocks of the image, the plurality of sub-blocks including sub-blocks with co-located pixels;
producing, by the processing device, a compressed set of color palette keys for the sub-blocks of the image responsive to the color palette cluster analysis;
averaging, by the processing device, respective color palette keys of the compressed set of color palette keys for the co-located pixels to obtain an adjusted set of color palette keys; and
outputting, by the processing device, a compressed image based on the adjusted set of color palette keys.

18. The method of claim 17, wherein the color palette cluster analysis is based on an initial set of colors of the image, luminance sorting, and a target number of palettes, and the luminance sorting includes:
obtaining a red-green-blue (RGB) value for the initial set of colors of the image;
converting each RGB value to a luminance value; and
sorting the luminance values to obtain a sorted index of luminance values.

19. The method of claim 18, further comprising:
partitioning the sorted index of luminance values into a target number of bins;
selecting center value for the bins; and
initializing the color palette cluster analysis responsive to each of the center values.

20. The method of claim 17, further comprising:
skipping the color palette cluster analysis for portions of the image below a threshold luminance value;
using a skipping pattern when adding pixels of the image to the color palette cluster analysis; and
weighting pixels added to the color palette cluster analysis.
